(19) United States
(12) Patent Application Publication
(10) Pub. No.: US 2018/0304447 A1
(43) Pub. Date: Oct. 25, 2018

(54) EMRID Electromagnetic pickup tool

(71) Applicant: Francis Gerard Truglio, Spotsylvania, VA (US)

(72) Inventor: Francis Gerard Truglio, Spotsylvania, VA (US)

(21) Appl. No.: 15/927,169

(22) Filed: Mar. 21, 2018

Related U.S. Application Data
(60) Provisional application No. 62/474,284, filed on Mar. 21, 2017.

(51) Int. Cl. B25B 11/00

(52) U.S. Cl. CPC B25B 11/002

(57) ABSTRACT

The present invention represents an electromagnet-based pickup & inspection tool/device for locating and the recovery of ferrous and unique to the present invention, nonferrous objects with a, and also unique to the present invention, an attachable gripping device, from confined spaces, such as engine compartments. Additional unique features of the present EMRID invention is the, use of LED illumination for wide area viewing, and a WIFI micro endoscope type of video camera for enhanced search & inspection capabilities, inclusive of, built-in LEDs.

### SECTION-G: BACKGROUND OF THE INVENTION

### Background

The currant invention was specifically designed to rectify the below issues related to current magnetic pickup tool/devices, such as:

1. Previous electromagnetic pickup tool designs were not wholly successful. Whereas, the lateral magnetic field-strength of an electromagnets is not sufficient to free and/or move an object into position where the field strength is greatest ‘1E’ at the electromagnet's face. It is the intent of the present invention, to rectify said problem. Solution: By viewing the present EMRID invention's video camera's image and aided by its built-in LED illumination, the operator of the EMRID will be able to locate and ascertain the optimum position to effect retrieval and thus, adjust/bend the device's flexible shaft, which in most cases, will negate said issue

2. Problems related to Permanent Magnet-PM-based pickup/retrieval tools & devices. Said PM based tools are inherently difficult to maneuver. Whereas, PM based tools are attracted to and will adhere to any ferrous object within its magnetic field; making recovery of a desired object, difficult to achieve. With said attraction-problem negating the use of powerful PM magnets. An incident such as a dropped wrench, with current retrieval tools, can easily escalate from simply frustrating a mechanic, to reducing or eliminating profit margins. Worse still, if say, a bolt fell into something where it could do damage if not retrieved, a costly teardown may be required. Solution: the EMRID's operator can keep the electromagnet off until it is within close proximity of the object needing extraction

3. Current recovery tools, including both, PM and Electromagnetic types cannot retrieve non-ferrous objects such as, aluminum, stainless steel and Brass bolts. Solution: by connecting the present EMRID invention's, gripping device (FIG. 1q) and activating the handle-mounted momentary switch, the arm/jaws (FIG. 2i), (FIG. 2h) can recover nonferrous objects that can fit between the gripping device's arms/jaws

4. Most current recovery tools do not have lights. Solution: the present invention has LEDs mounted in both the handle and in the micro video camera

5. Current devices do not have video cameras to provide enhanced search and/or inspections capabilities. Solution: the present invention has mounted above the electromagnet at the distal end of a flexible shaft, a micro WIFI-wireless-video camera; which can be viewed via a cell phone or other WIFI compatible monitoring device

6. PM magnet-based recovery tools are limited to hold/lifting objects of 2 or less pounds, whereas, the usage of more powerful permanent magnets will render them impractical. Solution: In addition to offering 2 basic models, low @ 4+.lbs holding capacity and a med @ 22+. lbs holding capacity, the present invention can also be configured with electromagnets of 100+. lbs, lifting capacities.

7. Current recovery tools cannot provide video data. 6b-Solution: data can be collected from the USB port (FIG. 1l) or the WIFI transmitter.

8. Consideration as to nearby objects must be taken before setting said current permanent magnet tools aside, whereas, a PM magnet's field will attract/collect ferrous objects and/or corrupt electronic devices. Solution: The present invention is based upon an Electromagnet. As such, it has almost no magnetic field when power is off.

### SECTION-1: FIELD OF THE INVENTION

The present EMRID invention relates to magnetic pickup tools of the types used for the retrieval of ferrous objects, such as, steel screws, washers, nuts, tools and other ferrous objects from inaccessible by hand locations; and more specifically, to Electromagnet-based pickup tools and devices.

### SECTION-H: BRIEF SUMMARY OF INVENTION

The present EMRID invention is a multifunctional, portable, hand-held, electromagnetic pickup and inspection tool/device for the capture and recovery of ferromagnetic and unique to the present invention: the capture and recovery non-ferromagnetic objects, from limited access locations, such as aircraft & vehicle engine bays. With the viewing of said locations enhanced by, illumination from LEDs (Light Emitting Diodes) on the handle's face for wide area viewing and, also unique to the present invention, a 5 mm HD WIFI micro-video camera with built-in LEDs for in-close viewing of hidden areas, such as, under and/or behind subcomponents. With said camera mounted close to the electromagnet at the distal end of a flexible & hollow shaft. The inverse end of said flexible shaft will attached to the distal end of a rigid & telescopic shaft (FIG. 1u) or with respect to short-reach (light-duty) EMRID models (FIG. 1v), a fixed rigid shaft.

The capture of, said non-ferromagnetic objects, such as, stainless steel bolts, brass washers, and/or plastic items, will be facilitated by an attachable, electromagnetically actuated gripping device; with said, gripping device being of endogenous design and also unique to magnetic pickup tools. Whereas, said micro video camera (FIG. 1n) (FIG. 5b) can be removed, it can also be deployed as an endoscope for the inspection of internal spaces such as an engine's cylinder bore.

### SECTION-i: BRIEF DESCRIPTION OF DRAWINGS/FIGURES

FIG. 1: Overall Conceptual Layout: of, side, top, front, & side cutaway Index of parts list Page-11

FIG. 2: Attachable Gripping device cutaway side view Index of parts list Page-12

FIG. 3: Electromagnet & Housing cutaway view Index of parts list Page-12

FIG. 4: Gripping Device, external front, rear, side, bottom views Index of parts list Page-13

FIG. 5: Micro video camera & mount, top, side & front views Index of parts list Page-13

FIG. 6: Dual fingered gripper arm, with capture object, a hex-head bolt

For the purpose of facilitating an understanding of the invention, there is illustrated in the accompanying drawings a preferred embodiment thereof, from an inspection of which, when considered in connection with the text descriptions, the invention, its construction and operation, and many of its advantages should be readily understood and appreciated.

### SECTION-i1: DRAWING-1 INDEX IDENTIFICATIONS

a-HANDLE body b-SWITCH for camera & LEDs c-Momentary toggle/trigger for E-mag d-Cell phone e-Cell phone mount f-Mounting point for outer shaft g-Flexible shaft h-Side cover screws i-Battery j-Charging socket k-Fuse l-USB port of WIFI video transmitter m-Clamp-on camera mount n-Micro video camera with built-in LEDs o-Electromagnet p-Inner telescopic shaft q-Attachable gripper r-Upper wide area LEDs s-Finger-twist clamp t-Outer telescopic shaft u-Compression slots v-Short reach model/type shaft w-Wire holding clips

### SECTION-i2: DRAWING-2 IDENTIFICATIONS

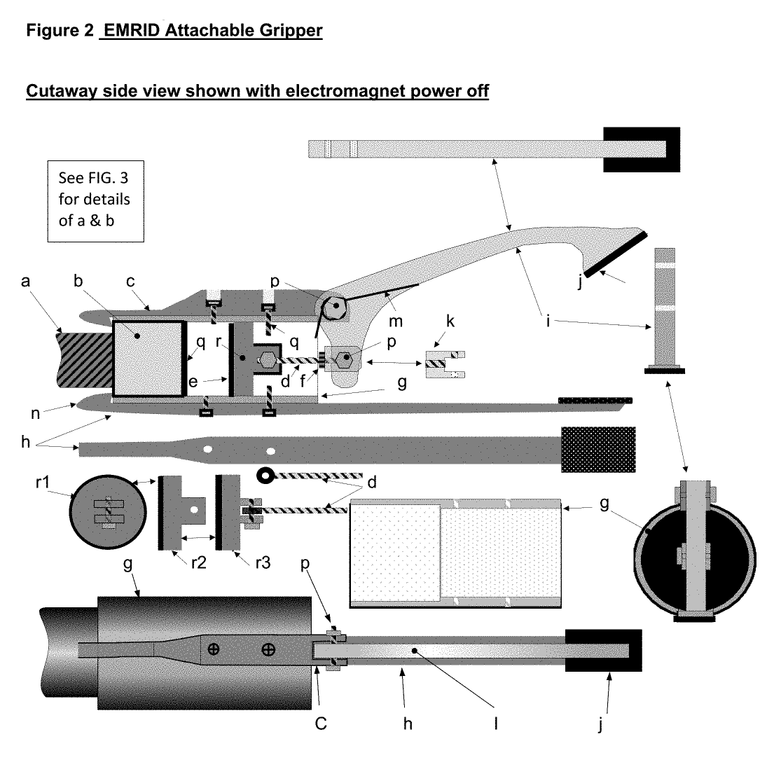

a-Flexible shaft b-Electromagnet housing c-Pivot arm mount/snap-clip d-Eye-hole-screw/linkage e-Iron piston face f-Locking nuts g-Electromagnet housing & piston cylinder h-Fixed arm i-Actuated arm j-Rubber pad k-Adjustable pivot block l-L not used letter m-Torsion spring n-Press-on flexible clip o-Locking clips p-Travel-limit & hold-down screw q-Upper pivot bolt r-Piston 3 views: r1-face, r2-OD side, r3=90° side shown with eye=hole-screw/linkage arm (FIG. 2F) inserted

### SECTION-i3: DRAWING-3 INDEX IDENTIFICATIONS

a-Electromagnet wires b-Flexible shaft/gooseneck and nonconductive of electricity c-Electromagnet housing d-Electromagnet

### SECTION-i4: DRAWING-4 INDEX IDENTIFICATIONS

a-Top view b-Front view c-Side view closed d-Bottom view e-Side view, open f-Rear view

### SECTION-:i5: DRAWING-5 INDEX IDENTIFICATIONS

a-flexible shaft b-camera c-camera mount d-front of camera LEDS e-electromagnet f-camera mounting hole g-adjusting screws h-electromagnet face I-cable clamp J-WIFI cable

### SECTION-i6 DRAWING-6 INDEX INDENTFICATIONS

a-Top view; gripper housing b-Top view, dual Gripping fingered actuated arm c-Front view, dual Gripping fingered actuated arm d-Example: a captured object, a hex-bolt e-Range of Arm travel

### SECTION-j: DETAILED DESCRIPTION OF INVENTION

The present EMRID invention is comprised of 5 main components:

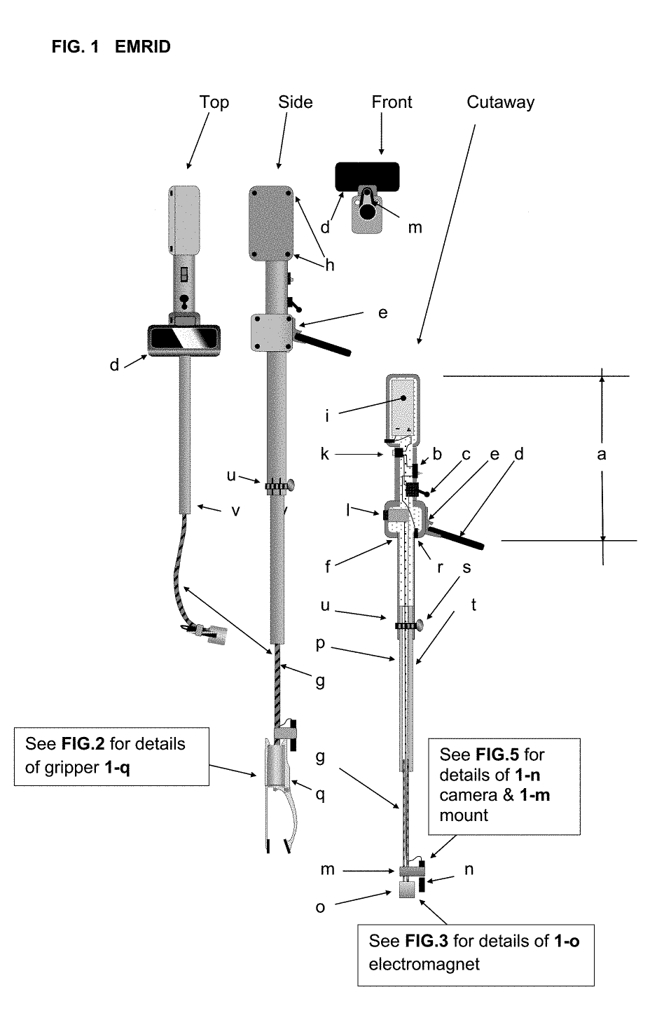

A handle (FIG. 1a) of endogenous design

A telescopic shafts (FIG. 1p), and/or, depending upon model type (FIG. 1t), a rigid shaft of endogenous design (FIG. 1v) and a flexible gooseneck shaft (FIG. 1g) such as a UNIPRISE Inc Model # 0.125-M

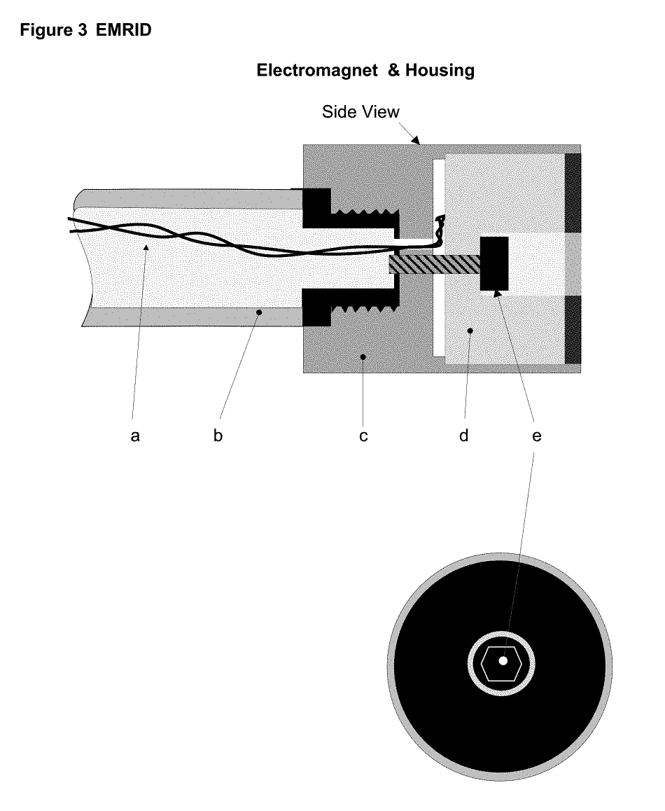

An electromagnet (FIG. 1o), (FIG. 2g), (FIG. 3d) such as an APW. EM137-24-222

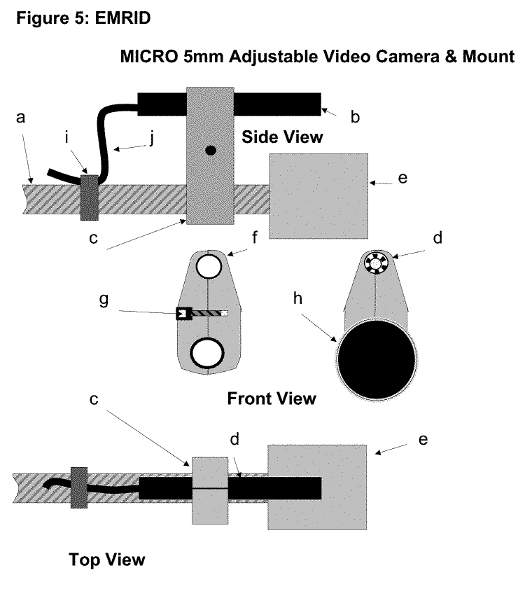

A micro video camera (FIG. 1n), (FIG. 5c) such as a TIAN WiFi Borescope video Inspection Camera and depending upon client, a customer provided cell phone

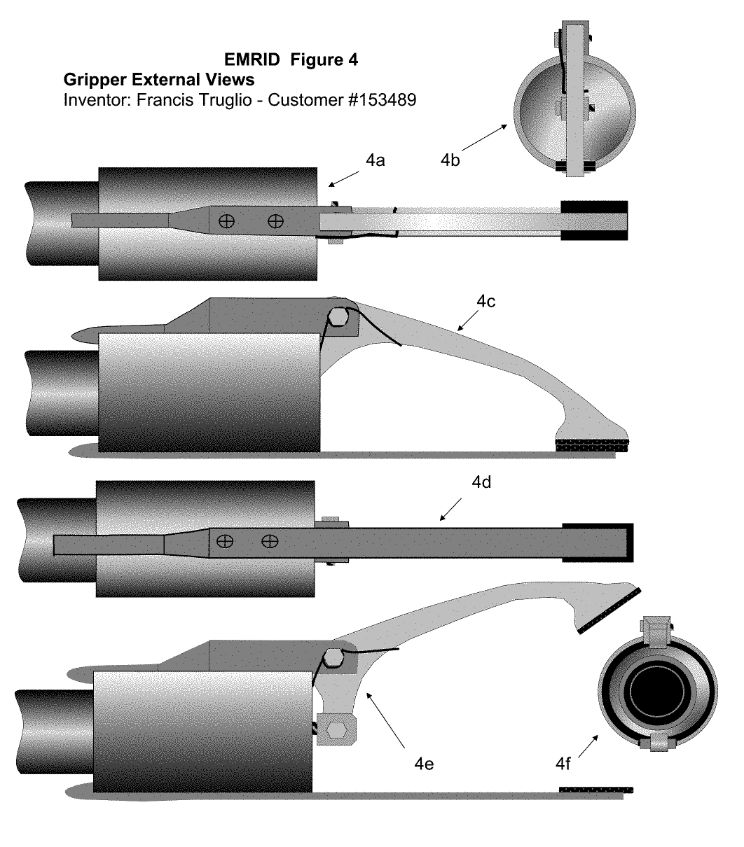

A gripping device (FIG. 1q), (FIG. 2a-q), (FIG. 4a-f) of endogenous design

EMRID is a multifunctional, portable, hand-held, electromagnetic pickup and inspection tool/device for the capture and recovery of ferromagnetic and unique to the present invention: the capture and recovery non-ferromagnetic objects, from limited access locations, such as aircraft & vehicle engine bays. With the viewing of said locations enhanced by, illumination from LEDs (Light Emitting Diodes) on the handle's face for wide area viewing and, also unique to the present invention, a 5 mm, 5.5 mm or 8 mm HD WIFI micro-video camera with built-in LEDs for in-close viewing of hidden areas, such as, under and behind subcomponents. With said camera mounted close to the electromagnet at the distal end of a flexible & hollow shaft. The inverse end of said flexible shaft will be attached to the distal end of a rigid & telescopic shaft or with respect to short-reach (light-duty) EMRID models (FIG. 1v), a fixed rigid shaft. A bonding agent or threads will be used to attach either shaft types to said tool's handle. With said handle (FIG. 1a), further comprising:

1. a rechargeable battery (FIG. 1i)

2. a switch for said LEDs (FIG. 1b)

3. a removable side access panel (FIG. 1h)

4. a cell phone (FIG. 1d)

5. a WIFI transmitter with a USB connector (FIG. 1L)

6. a reinforced mounting point (FIG. 1f) inclusive of a tapped/threaded hole for said flexible shaft

7. a mini=blade type automotive fuse (FIG. 1k) for said battery

The EMRID device further comprising:

8. a fixed rigid or telescopic outer shaft (FIG. 1t), with said outer shaft affixed to the tool's handle (FIG. 1a) by a bonding agent or threads at the forward (FIG. 1f) end said handle. With said outer shaft housing an inner shaft (FIG. 1p); the distal end of which being tapped/ threaded to accept the male threads of a hollow flexible (FIG. 1g) shaft; with the distal of said flexible shaft threading into the electromagnet (FIG. 1o) housing (FIG. 3c)

9. a 360 degree ratable adjustable mount (FIG. 1m), (FIG. 5) for said micro video camera

10. a 5-8 mm HD WIFI micro video camera with built-in LEDs (FIG. 1n), (FIG. 5b)

11. a cylindrical housing (FIG. 3 c) for said electromagnet having a centered and tapped/threaded hole (FIG. 3b) for said flexible shaft and depending upon electromagnet type, either a threaded or smooth hole for the electromagnet mounting cap screw (FIG. 3e)

12. The capture of said non-ferromagnetic objects, such as, stainless steel, brass, copper and plastics, to be facilitated by an attachable, electromagnetically actuated gripping device. With said gripping device (FIG. 1 q), (FIG. 2), (FIG. 4a-f) being of endogenous design and further comprising:

13. an electromagnetically actuated gripping arm (FIG. 2i)

14. a fixed gripping arm (FIG. 2h)

15. an upper mount (FIG. 2c)with a pivot-point for said actuated arm, inclusive of a snap-in finger (FIG. 2m) for locking of said gripping device to the electromagnet (FIG. 2g),(FIG. 3c) housing

16. an iron-faced piston (FIG. 2r), with said piston connected by an eye-hole-screw (FIG. 2f)) to an adjustable pivot block (FIG. 2k) for the activation of said arm (FIG. 2i) by electromagnet (FIG. 2b) enclosed in a cylinder (FIG. 2g) with a (FIG. 2d)

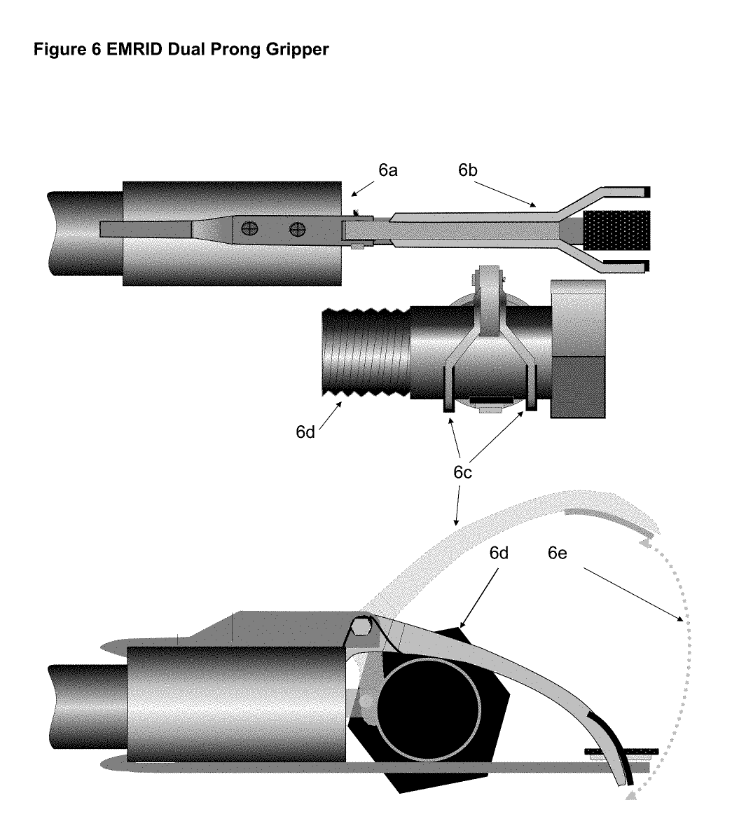

17. rubber non-slip gripping pads at the distal end of said arms (FIG. 2j)(FIG. 2h, FIG. 6f)

18. a torsion spring (FIG. 2m) to hold said actuated gripping arm open when power to the electromagnet is off

Note: All electronic components of the present invention to be connected with insulated & stranded wires with those for the electromagnet coil being contained within said hollow flexible shaft (FIG. 1g) and/or a telescopic (FIG. 1p) or fixed shaft (FIG. 1w). Said wires will be coiled, to permit full extension and retraction of said shafts.

Additionally: with the exceptions of the adjustable aluminum pivot block (FIG. 2k),the iron piston face (FIG. 2r) and a finger-twist type hose clamp (FIG. 1s), such as an Ideal Clamps, product # 318-5Y02858, and the internal steel piston, the present invention will be manufactured from nonconductive of electricity materials or insulated; to avert accidental short circuits. Such as the EMRID's flexible shaft or another component/s making contact with live positive 12 volts battery voltage and negative 12 volts battery voltage.

What is claimed is: A multifunctional, portable, (hand-held) electromagnetic pickup and inspection tool/device for the capture and recovery of ferromagnetic, and unique to the present invention: the capture and recovery non-ferromagnetic objects, from limited access locations, such as automotive engine bays. The viewing of said locations enhanced by, and, also unique to the present invention, illumination from LEDs (Light Emitting Diodes) on the handle for wide area viewing and a WIFI micro-video camera with built-in LEDs for close viewing, mounted before said tool's electromagnet with said electromagnet mounted at the distal end of a flexible & hollow (gooseneck) shaft. The inverse end of said flexible shaft attached to the distal end of a rigid plastic telescopic shaft, that is connected by a bonding to said tool's handle. The Camera and flexibility of said shaft allowing for the viewing of hidden areas by a cell phone mounted on said tool's handle. The capture of said non-ferromagnetic objects, facilitated by an attachable, electromagnetically actuated gripping device. Said endogenous design device is also unique to magnetic pickup tools. Comprising:

1. a plastic (PVC) & rigid telescopic outer shaft (FIG. 1u), with said shaft affixed to the tool's handle (FIG. 1f) by a bonding agent. Said shaft housing an inner PVC shaft (FIG. 1p). The distal end of which is tapped/threaded to accept the male threads of said hollow flexible (FIG. 1g) shaft. The distal of said flexible shaft will thread into the electromagnet (FIG. 1o) housing (FIG. 3)
1a-a rechargeable battery (FIG. 1i) 1b-a switch for said LEDs (FIG. 1b)
1c-a momentary trigger/switch (FIG. 1c) for the activation of said electromagnet
1d-Cell phone(FIG. 1d) and cell phone mount (FIG. 1e)
1e-a recharging socket (FIG. 1j) for said battery
1f-a cell phone (FIG. 1d)

2. a plastic handle (FIG. 1a) with a removable side, further comprising:
1g-a WIFI transmitter with a USB connector (FIG. 1L)
1h-a reinforced mounting point (FIG. 1f) inclusive of a tapped/threaded hole for said flexible shaft
1i-a fuse (FIG. 1k) for said battery

3. a snap-in adjustable mount (FIG. 1m, FIG. 5) for said micro video camera

4. a 5 mm HD WIFI micro video camera with built-in LEDs (FIG. 1n, FIG. 5b)

5. a cylindrical PVC housing (FIG. 3c) for said tapped/threaded electromagnet having a hole for said flexible shaft and a tapped/threaded hole (FIG. 6e) for said electromagnet mounting bolt

5. a attachable gripping device (FIG. 2, FIG. 4, FIG. 6) for the capture of said non-ferromagnetic objects, such as stainless steel, aluminum and plastics. Further comprising:
5a-an outer electromagnet PVC housing/cylinder (FIG. 2g, FIG. 3c) for encasement of electromagnet housing (FIG. 10)
5b-a electromagnetically actuated arm and interchangeable with other gripping arm types (FIG. 2i) such as (FIG. 6).
5c-a upper mount (FIG. 2c) with a pivot-point for said actuated arm, inclusive of a snap-in finger (FIG. 2n) for locking/retaining of said gripping device to the top of said electromagnet housing
5d-a fixed arm, inclusive of a snap-in finger (FIG. 2n) for retaining said gripping device to the bottom of said electromagnet housing
5e-a steel piston (FIG. 2e) enclosed in a PCV plastic cylinder (FIG. 2g) with said piston connected by a screw (FIG. 2D) to an adjustable pivot block (FIG. 2k) for activation of said arm (FIG. 2i) by electromagnet (FIG. 2b)
5f-Rubber non-slip gripping pads at the distal end of said arms (FIG. 2j, FIG. 2h, FIG. 6f)
a torsion spring (FIG. 2m) to hold said actuated gripping arm open when power to the electromagnet is off

6. All electronic components of the present invention will be connected with insulated & stranded wires; with those contained inside of said telescopic shafts (FIG. 1u, FIG. 1p) coiled to permit full extension and retraction of said shafts.
Note: with the exceptions of the adjustable aluminum pivot block (FIG. 2k), a hand-twist type hose clamp (FIG. 1v), such as an Ideal Clamps, product # 318-5Y02858, and the internal steel piston, the present invention (FIG. 1) will be manufactured from nonconductive (of electricity) materials or insulated; to avert an accidental short circuit. Example: should said shafts contact live positive battery voltage.
